(19) United States
(12) Patent Application Publication
(10) Pub. No.: US 2008/0303918 A1
(43) Pub. Date: Dec. 11, 2008

(54) COLOR CORRECTING FOR AMBIENT LIGHT

(75) Inventor: Douglas Gene Keithley, Boise, ID (US)

Correspondence Address: RatnerPrestia, P.O. BOX 980, VALLEY FORGE, PA, 19482, US

(73) Assignee: MICRON TECHNOLOGY, INC., Boise, ID (US)

(21) Appl. No.: 11/760,990

(22) Filed: Jun. 11, 2007

(51) Int. Cl. H04N 9/73

(52) U.S. Cl. 348/223.1

(57) ABSTRACT

An apparatus and method are described for adjusting the color balance of a display. According to the method, a sensor of the apparatus detects the color temperature of ambient light. A controller of the apparatus adjusts the color balance of the emissive display based on the detected color temperature of ambient light.

### BACKGROUND OF THE INVENTION

The present invention relates to color correcting for ambient light and, more particularly, to a device and method for adjusting the white balance point of a display based on ambient lighting conditions.

Colors appear differently to the human eye under different ambient lighting conditions. This has traditionally presented a problem for photographers and videographers. With respect to digital still cameras (DSCs), for example, a photographer may capture an image under one light source and then view a verification image on a display. Without some color correction applied to the verification image, the colors in the verification image may appear different than the colors in the image when it is later printed or developed. Similarly, different films and developing techniques may alter the appearance of the colors from the appearance of the colors viewed while the picture was originally taken. With respect to video cameras, for example, without some color correction applied to a captured video, the colors in the video may appear differently when played back on a display than they did when the videographer originally captured the video.

The appearance of colors in images typically depends on the white point of the image. The appearance of colors may be made consistent for some devices, such as the DSCs and video cameras described above, by setting a single white balance point for the device. The white balance point of an image is the definition of the color “white” for the image and is typically defined by the “color temperature” of the illuminant. One such illuminant may be daylight. The white point corresponding to daylight, for example, may be expressed according to the relative intensities of different colors of light that make up daylight or as the color temperature of daylight. For example, daylight may be expressed according the relative intensities of red, green and blue light that make up daylight. Alternatively, daylight may be expressed according to its color temperature, which is approximately 5000K.

Color temperature is a characteristic of visible light and may be determined by comparing the hue and brightness of visible light to a theoretical heated black-body radiator. The temperature in degrees Kelvin at which the black-body radiator matches the hue of the visible light is the color temperature of the visible light. For visible light that does not match the temperature of a black-body radiator, the color temperature of the visible light is referred to as the correlated color temperature of the visible light. The correlated color temperature is the color temperature of the black-body radiator that is closest to the hue and brightness of the visible light.

Conventionally, the white point of a camera may be periodically calibrated to define white relative to the appearance of a white target under ambient lighting conditions. This may be done by placing a white target in the field of view of the camera and adjusting the white point of the pixels corresponding to the target to the fixed white point. That is, the white point for the camera may be set by transforming the color temperature of the white pixel in the captured image to the color temperature of the camera's white point and adjusting the other color pixels in the image proportionately. Thus, when the video is reproduced on a standard display under ideal viewing conditions, it will appear the same no matter what ambient lighting was used during the image capture.

### BRIEF DESCRIPTION OF THE DRAWINGS

These and other features, aspects, and advantages of the embodiments of the present invention discussed below will become more fully apparent from the following description, appended claims, and accompanying drawings in which the same reference numerals are used for designating the same elements throughout the several figures, and in which:

FIG. 1 is a block diagram of an example system for adjusting the white point of a display according to an embodiment of the present invention.

FIG. 2 is a flow chart for a method of adjusting a lighting unit based on measured ambient light according to the example system shown in FIG. 1.

FIG. 3 is a flow chart for a method of adjusting the display drive of a display based on measured ambient light according to the example system shown in FIG. 1.

FIG. 4 is a flow chart for a method of determining an adjustment value for adjusting a display drive or a lighting unit according to the example methods of FIG. 2 and FIG. 3.

FIG. 5 is a flow chart for another method of determining an adjustment value for adjusting a display drive or a lighting unit according to the example methods of FIG. 2 and FIG. 3.

FIG. 6A is a front view of an example cellular telephone incorporating the embodiments of FIGS. 1-5.

FIG. 6B is a back view of an example cellular telephone incorporating the embodiments of FIGS. 1-5.

FIG. 7 is an example of a lens and sensor combination that may be used with an embodiment of the present invention.

### DETAILED DESCRIPTION OF THE INVENTION

Lighted displays, and especially portable lighted displays, present a different problem. These displays are viewed in ambient illumination. Thus, if a display has a fixed white point corresponding to sunlight but is viewed in an environment with fluorescent lighting, the colors on the display will appear to be different from the same colors in the ambient environment. This is especially true in brightly lighted environments. In dimly lighted environments, in which the display is significantly brighter than the environment, the color temperature of the ambient light may not be as significant a factor when viewing the display.

By way of example, suppose a photographer in the art department for IPOD takes a picture of a white IPOD in an illuminated viewing booth. The photographer subsequently displays the image on the IPOD and views the displayed image in the viewing booth under the same illumination under which the image was captured. To the photographer, the white in the image perfectly matches the white of the IPOD's casing. The next morning, the photographer carries the IPOD outside and views the image again. This time, the white IPOD in the image may appear bluer than it was in the viewing booth. The displayed image no longer matches the IPOD's actual casing. The photographer then carries the IPOD back to the office. This time, the white IPOD in the image may appear redder than it was in the viewing booth. The photographer immediately alerts the IPOD production department to let them know the IPOD display is defective.

The photographer is wrong. The display is not defective, it is just not ideal. The change in the appearance of the colors is due to differences in the illumination. For example, when outside in the morning, the illumination has relatively more red light than the illumination in the viewing booth. This causes the coloring of the case to have a higher relative red content than the image of the IPOD on the display. Because most of what the photographer sees is dominated by the surroundings and not by the small display, the display may appear slightly blue. The opposite occurs under fluorescent illumination, which has relatively more blue than the illumination in the viewing booth. This causes the coloring of the case to have a higher blue content than the image of the IPOD on the display. Again, because most of what the photographer sees is dominated by the surroundings and not by the small display, the display may appear slightly red.

The example embodiments of the present invention, described below, mitigate this problem by matching the white point of the lighted display to the sensed ambient lighting. Thus, similar colors will not appear to be different on the display and in the environment. With respect to the IPOD example, using the example embodiments of the present invention described below, the white IPOD on the display will appear the same in the viewing booth, outside, in the office, at home and anywhere else the photographer may view the image of the white IPOD displayed by the white IPOD itself.

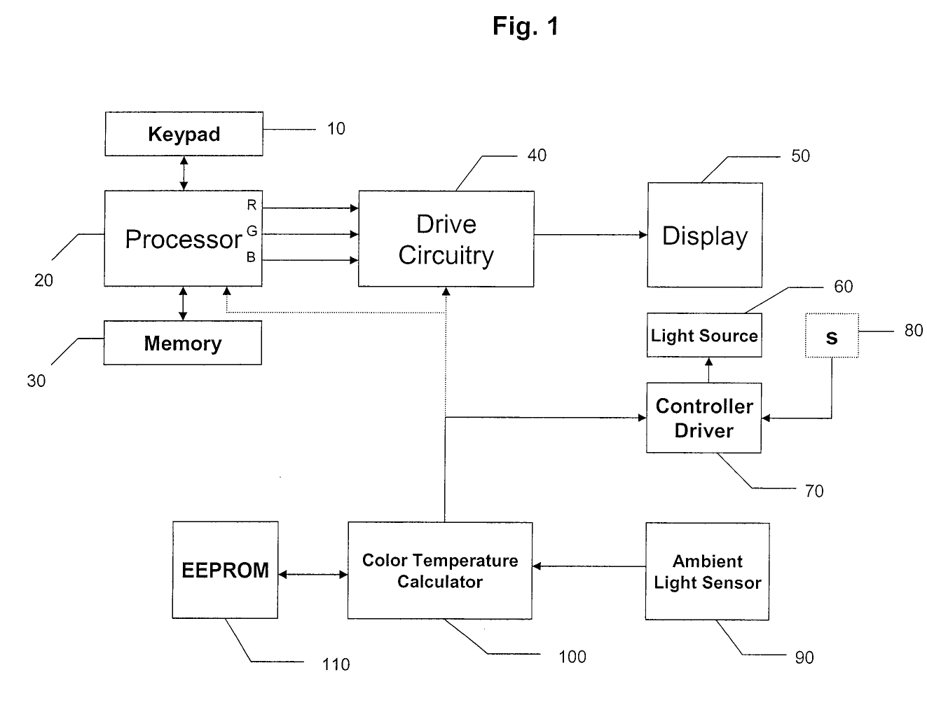

FIG. 1 is a block diagram of one example system for adjusting the white balance point of a display based on ambient lighting conditions. The example system includes display 50 for displaying an image, light source 60 for lighting display 50, controller driver 70 for controlling the drive of light source 60, drive circuitry 40 for driving display 50 and optional light sensor 80 for optionally monitoring the performance of light source 60. The system further includes ambient light sensor 90 for measuring ambient light, optional imager 92 for optionally measuring ambient light and capturing images, optional imager output processing unit for processing values output by imager 92 so that the values may be used by color-temperature calculator 100, optional EEPROM 110 for storing ambient light reference values and color temperature calculator 100 for calculating an adjustment value to adjust the white balance point of the display to compensate for the sensed ambient light. Optionally, the system includes keypad 10, processor 20, and memory 30, which illustrate the components of a device included in the example system. The system of FIG. 1 may be used to carry out white balancing for a number of functions including, but not limited to, display color balancing, video processing and DSC image processing.

While the examples described below concern lighted displays, it is contemplated that the invention may also be practiced with emissive displays such as organic light emitting diode (OLED) displays, plasma displays or field emissive displays (FEDs). For emissive displays, the white balance point may be set by adjusting the color processing circuitry.

In one embodiment of the present invention, the example system of FIG. 1 may be configured to adjust the white point of display 50 by comparing ambient light values sensed by ambient light sensor 90 with reference ambient light values stored in EEPROM 110. It is contemplated that the adjustment may be performed only when the ambient light is above a predetermined threshold. This threshold may be determined experimentally by selectively applying the correction in a number of different environmental conditions representing different lighting levels to determine at which lighting level the correction becomes apparent.

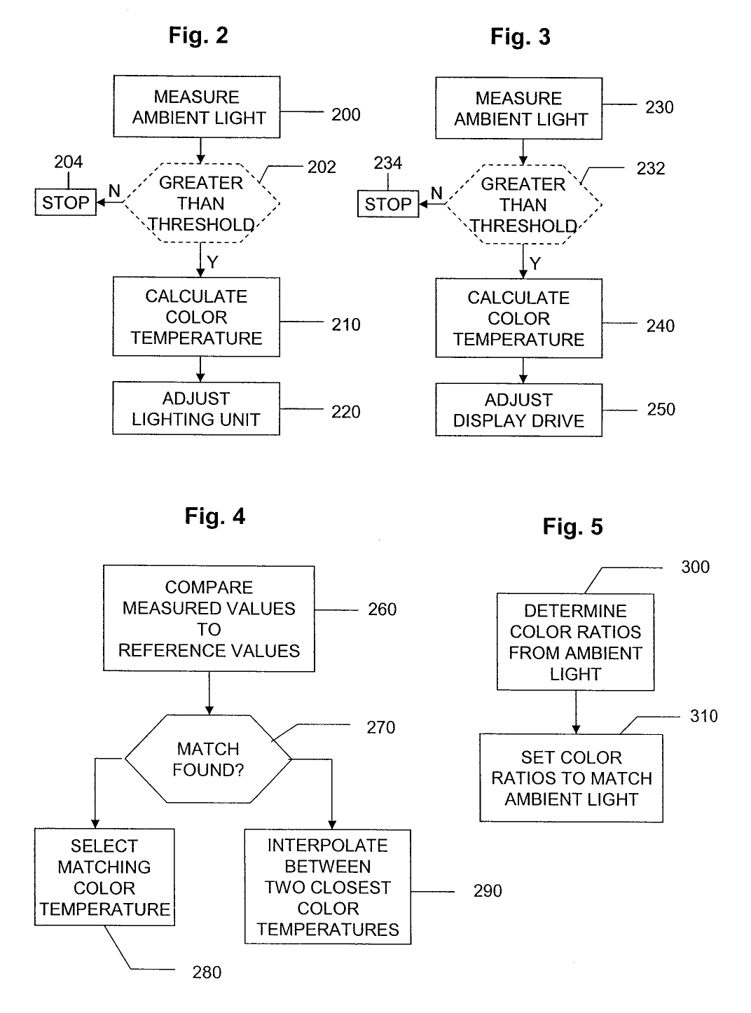

At step 200 of FIG. 2 or step 230 of FIG. 3, ambient light sensor 90 may detect the ambient light. Next, at optional step 202 of FIG. 2 or step 232 of FIG. 3, the process determines if the ambient light level is greater than the predetermined threshold. If it not, no correction is needed and the process may terminate at step 204 of FIG. 2 or step 234 of FIG. 3. If the ambient light is greater than the threshold at optional step 202 or 232, then the process continues, at step 210 of FIG. 2 or step 240 of FIG. 3, to adjust the color temperature of the display to be compatible with the detected ambient light.

Ambient light sensor 90 may be any RGB or other color sensor or imager. One suitable RGB sensor may include at least three pixels, although it may include an array of many pixels. Each pixel may include a photosensitive element and a color filter. At least one of the pixels may be a red pixel, for example, having a red filter disposed over it, another one of the pixels may be a green pixel, for example, having a green filter disposed over it and another one of the pixels may be a blue pixel, for example, having a blue filter disposed over it. The red, green and blue filters may function to pass only light having a wavelength corresponding to the assigned color and to reflect or absorb all other wavelengths. For example, the red filter may pass a band of light centered at a wavelength of 650 nm, the green filter may pass a band of light centered at a wavelength of 510 nm and the blue filter may pass a band of light centered at a wavelength of 475 nm. The passed light may enter the photosensitive element and the photosensitive element may produce a signal proportional to the intensity of the light striking the photosensitive element. The signal may then be read from each red, green and blue pixel and may eventually be converted to a digital signal representing the relative intensities of the colors red, green and blue in the ambient lighting. Using these signals, the color temperature of the ambient light may be determined. While this suitable sensor detects different colors using color filters disposed over the pixels, other sensors may separate colors using other mechanisms such as prisms or diffraction gratings. Such other sensors may also be suitable for use as ambient light sensor 90.

Avago Technologies' APDS-9002 sensor may, for example, be adapted for use as ambient light sensor 90. For example, disposing color sensors over at least three pixels of the APDS-9002 may form an excellent ambient light sensor 90 due to its responsivity being close to the response of the human eye.

At step 210 of FIG. 2 or step 240 of FIG. 3, the example color temperature calculator 100 in combination with EEPROM 110 may calculate an adjustment value for adjusting the color temperature of the display by, at step 260 of FIG. 4, comparing the values of the brightest sensed instance of the ambient light with reference ambient light values stored in EEPROM 110. Then, at step 220 of FIG. 2 or step 250 of FIG. 3, color temperature calculator 100 may either instruct drive circuitry 40 to adjust the drive for display 50, instruct processor 20 to adjust the drive for display 50 or instruct controller driver 70 to adjust the color temperature of lighting unit 60.

As described above, image data provided to the display has been transformed to a fixed white point by the camera system used to obtain the image data. The color temperature calculator determines the correction needed to transform images referenced to this fixed white point to the white point corresponding to the ambient illumination.

The reference values stored in EEPROM 110 may be stored, for example, in a lookup table (LUT). An example LUT is shown in Table 1 below. This LUT includes white point reference values in the RGB color space. It is contemplated, however, that these values may be, for example, in the CE XYZ tristimulus color space, the Long, Middle and Short (LMS) color space which mimics the cone response of the human eye, or any other color space. As shown, the LUT may include three columns, each corresponding to a separate one of the RGB coordinates. Each row in this table corresponds to a respectively different illuminant, in this example, incandescent light, moonlight and daylight. In this example, it is assumed that the fixed white-point of the image data corresponds to daylight. Thus, the values R3, G3 and B3 correspond to the white point of the received data. Where the correction is applied to a light source of a lighted display, the values from the table may be used to directly modify the Red, Green and Blue light sources. Where the correction is applied to the color signals for an emissive display or for a lighted display having a white light source, the color temperature calculator may define a transformation for the R, G and B image signals from the fixed white point to the calculated ambient white point.

TABLE 1

| | Converted Sensor Readings | | |
|---|---|---|---|
| | R | G | B |
| Incandescent Light (2800K) | R1 | G1 | B1 |
| Moonlight (4100K) | R2 | G2 | B2 |
| Daylight (5000K) | R3 | G3 | B3 |

One simple method for transforming an image from the daylight white point to a white point corresponding to incandescent light is to multiply the received R color signal by R1/R3, the received G color signal by G1/G3 and the received B color signal by B1/B3.

This transformation, however, may result in erroneous colors. Alternatively, the EEPROM 110 may be programmed with multiple color transformation tables, one for each of a set of fixed ambient light conditions. Each of these tables may be used to program a memory, for example, in the drive circuitry 40, which transforms the R, G and B signals provided by the processor 20 into R, G and B signals corresponding to the white point of the sensed ambient illuminant. Each of these tables may, for example, receive three 8-bit address values, corresponding to the R, G and B color values for a pixel and provide transformed 8-bit R, G and B values.

Where the ambient illuminant does not match one of the illuminants in the LUT, the appropriate color values may be interpolated. For a lighted display, the drive signals for the Red, Green and Blue light sources may be interpolated between appropriate pairs of the R, G and B values in the table. For emissive displays or lighted displays having a white light source, transformation tables may be interpolated from the appropriate transformation tables stored in the EEPROM 110.

As an alternative to using the transformation tables, the white point transformations may be accomplished using data processing circuitry in the drive circuitry 40 or processor 20. These circuits may be programmed, for example, to implement a transform from the white value of a display to the white value of the ambient light. One simple example transformation includes converting the image illuminant to a linear space, multiplying each component by the ratio of the ambient light value to the reference white value in the converted color space and then converting the converted display values back to the display's color space. For example, if the display's color space is sRGB (standard RGB), the white value of the display may first be converted to a linear space by removing the gamma correction from the sRGB signal or by converting the sRGB signals to an XYZ color space. Converting from one color space to another, such as converting from the sRGB color space to an XYZ color space, is well known in the art. Next, each component is multiplied by the ratio of the ambient light white value to the reference white value in the XYZ color space, such as by the following equations: Xdisplay=Ximage*(Xambient/Xreference); Ydisplay=Yimage*(Yambient/Yreference); and Zdisplay=Zimage*(Zambient/Zreference). This may be stated as the following matrix equation.

$$\begin{matrix}[ XdisplayYdisplayZdisplay ] = [ XimageYimageZimage ] \\ [ \begin{matrix}\frac{Xambient}{Xreference} & 0 & 0 \\ 0 & \frac{Yambient}{Yreference} & 0 \\ 0 & 0 & \frac{Zambient}{Zreference}\end{matrix} ]\end{matrix}$$

Display values (Xdisplay, Ydisplay, Zdisplay) corrected for viewing conditions are generated from the image values (Ximage, Yimage, Zimage) that are based on a standard reference value. If, for example, the ambient illumination and reference illumination are identical, the matrix may be an identity matrix and, accordingly, the display values may be identical to the image values.

The converted values may then be converted back to the sRGB color space. Where saturation is a concern, each of the three ratios described above may be scaled by the same factor so that the largest ratio is 1. An example scaling factor may be represented by the following equation equation: scaling factor=1/maximum (Xambient/Xreference, Yambient/Yreference, Zambient/Zreference).

While the above example is described in terms of a conversion from the sRGB color space to the XYZ color space, conversion between many color spaces are well known in the art and applicable for programming the drive circuitry. Additionally, the above example describes a simple conversion from one color space to another. More complicated conversions that may also account for brightness differences, for example, are also well known in the art. An example of such a conversion may be a von Kries transform. This transform is based on the matrix described above and may be adapted so that a scale value other than 1 may affect more than a single X, Y or Z value.

While ambient light sensor 90 detects red, green and blue light, it is contemplated that two of the three colors may be adjusted relative a stable third color to adjust the white balance point for the brightest instance of ambient light. If, however, it is desirable to adjust the white balance point for less bright instances of ambient light, a third adjustment value may be included in the LUT for adjusting the brightness of the display based on the ambient light level.

While the example LUT shown in Table 1 includes red, green and blue sensor readings and uses red and blue intensity values to adjust the white balance point, other colors may be used for this purpose. For example, sensors measuring the colors cyan, magenta and yellow may be used, although any sensor measuring any three or more colors that span a target color space may also be used. Likewise, any two or more colors may be used to adjust the white balance point of the display.

Although the memory 110 is shown as an EEPROM, it is contemplated that it may be implemented as a read only memory (ROM), flash memory or other non-volatile memory device.

After comparing measured values to reference values at step 260 of FIG. 4, in one embodiment, color temperature calculator 100 determines which reference illuminant value is closest to the measured ambient light. Then, at step 280 the example color temperature calculator 100 selects the adjustment intensity value(s) corresponding to the color temperature that best approximates the color temperature of the ambient lighting. For example, if the example color temperature calculator 100 determines that ambient light sensor 90 detected ambient lighting having a color temperature of 4900 K, color temperature calculator 100 may select the adjustment value(s) for the white pixels corresponding to daylight at 5000 K.

Alternatively, in another embodiment, the example color temperature calculator 100 may compare the values detected by ambient light sensor 90 to the reference ambient lighting values stored in EEPROM 110 at step 260. At step 270, the example color temperature calculator 100 looks for a close match. If a close match is found, for example if the values of the ambient light are within five percent of the intensity values for a color temperature of 5000 K, color temperature calculator 100 may select the adjustment value(s) for the white pixels corresponding to the matching reference value. If a close match is not found at step 270, for example if the intensity values of the ambient light correspond to a color temperature of 4900 K, color temperature calculator 100 may proceed to step 290 and interpolate between the two closest color temperatures. In this example, color temperature calculator 100 linearly interpolates each of the color components between daylight at 5000 K and moonlight at 4100 K to determine interpolated adjustment values for the white pixels. In this way, the system of this embodiment may perform a more sensitive adjustment of the white point based on the ambient lighting.

Where exact color appearance is desirable, color temperature calculator 100 may be configured to calculate an adjustment value for the white point of the display exactly, based on the ambient light values sensed by ambient light sensor 90.

In the embodiment described in FIG. 5, instead of using the reference values stored in EEPROM 110 to determine an adjustment value for adjusting the white point of the display, the example system adjusts the white point of the display directly. At step 300, color temperature calculator 100 may, for example, calculate the color ratios of ambient light sensed by ambient light sensor 90 based on the converted intensity readings from the ambient light sensor. Such color ratios may be, for example, the ratios of the intensities of red, blue and green light that make up the brightest instance of ambient light sensed by ambient light sensor 90. At step 310, color temperature calculator 100 may adjust light source 60 or drive circuitry 40 by setting color ratios of display 50 to match the sensed color ratios. This may be done, for example, by using controller driver 70 to adjust the relative intensities of red, green and blue light elements making up light source 60 to match the sensed ratios of red, green and blue in the brightest sensed instance of ambient light.

The system of FIG. 1 may be used to set the white balance of any type of display such as, for example, liquid crystal displays (LCDs), field emissive displays (FEDs), electroluminescent (EL) displays, cathode ray tube (CRT) displays, digital light processing (DLP) displays, plasma displays and organic light emitting diode (OLED) displays. The system of FIG. 1 may also be used in conjunction with any type of lighting unit including white only backlights and backlights with individual color components, e.g., red, green and blue lights.

As shown in FIGS. 2 and 3, after color temperature calculator 100 calculates the adjustment values and ratios for the white point of the display, the system of FIG. 1 may adjust the color balance in at least three different ways. For example, at step 220 of FIG. 2, controller driver 70 may receive the adjustment values and ratios and adjust the red, green and blue components of the light source to the adjusted color temperature. Alternatively, at step 250 of FIG. 3, drive circuitry 40 may receive the adjustment values and ratios and adjust the image signal applied to the display. In another alternative, the adjustment value may be applied to the processor 20.

Adjusting light source 60 via controller driver 70 at step 220 of FIG. 2 would typically be used for lighted displays having adjustable individual color components or for other types of lighted displays, such as DLP or liquid crystal on silicon (LCOS) displays, for which the reflected light sources may be adjusted. For such displays, each pixel may pass or reflect, for example, either red, green or blue light, or each pixel may include three sub-pixels, each of the three sub-pixels passing or reflecting, for example, either red, green or blue light. Because white light consists of different ratios of red, green and blue light, the color balance of the display may be adjusted by adjusting the relative intensity of the red and blue light sources until a desired color temperature for the display is reached. For example, if the color temperature of the ambient light is higher than the color temperature of the display, increasing the intensity of the blue pixels or sub-pixels may raise the color temperature of the display and if the color temperature of the brightest sensed instance of the ambient light is lower than the color temperature of the display, increasing the intensity of the red pixels or sub-pixels may lower the color temperature of the display. For such displays, controller driver 70 may adjust the voltage applied to each red, green and blue lighting element, thus adjusting the relative intensities of red, green and blue in the pixels or sub-pixels according to the adjustment amount calculated by color temperature calculator 100 in step 210 of FIG. 2.

Adjusting the display drive at step 250 of FIG. 3 may be used for any type of display or backlight. Here, at step 250 of FIG. 3, drive circuitry 40 may adjust the image signal applied to display 50 according to the adjustment ratio calculated by color temperature calculator 100 in step 240. The same technique may be used when the adjustment value is applied to the processor 20.

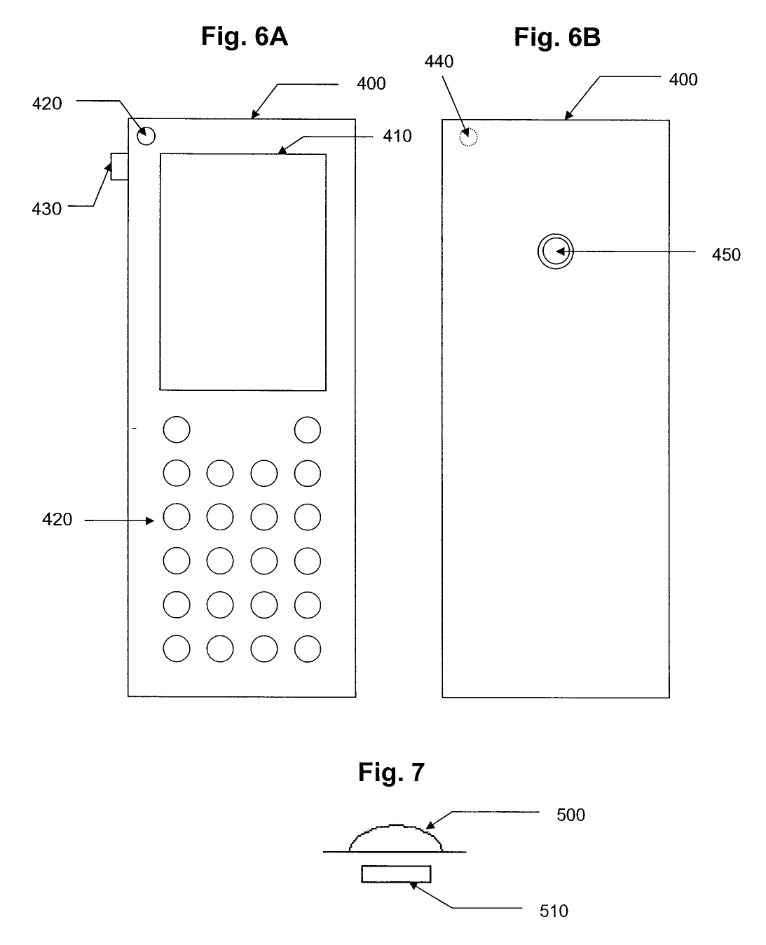

The example system of FIG. 1 may be used in any device that includes a display. For example, the example system may be used in a portable device such as the camera phone shown in FIGS. 6A and 6B as well as in cameras, watches, lap top computers, portable game systems, PDAs, portable CD players, portable DVD players, MP3 players, and so on. In these systems, which are used both indoors and outdoors under often widely varying ambient lighting conditions, the effect of white balancing according to any of the embodiments of the present invention would be most noticeable. However, the system of FIG. 1 may also be used in non-portable devices such as televisions and desk top computers to compensate for the varying ambient lighting conditions, particularly in applications where more exact color appearance is desirable. In an office environment, for example, a computer monitor may be used in sunlight, fluorescent light or a mixture of the two.

One example of a camera phone utilizing a system similar to that of FIG. 1 is shown in FIGS. 6A and 6B. FIG. 6A shows a front view of the camera phone and FIG. 6B shows a back view of the camera phone. The camera phone may include housing 400, display 410, ambient light sensor 420 disposed on the front of housing 400, button 430, keypad 420, imager 450 for carrying out the camera function of the phone and optional ambient light sensor 440 disposed on the back of housing 400.

As shown in FIGS. 6A and 6B, ambient light sensor 90 may be disposed on the front of housing 400 of the camera phone as shown in 6A, may be disposed on the back of housing 440 as shown in FIG. 6B or may be disposed on both the front and the back of housing 440. Locating the ambient light sensor on the front of housing 400, as shown in FIG. 6A, may be desirable because, in this position, it may provide a better approximation of the ambient lighting conditions in the vicinity of the screen. It may be desirable, however, to locate the ambient light sensor on the back of the housing, as shown in FIG. 6B, due to space and design constraints and so that the sensor is not influenced by reflections from the user's clothing. Alternatively, it may be desirable to include two ambient light sensors, one on the front of the housing and one on the back of the housing, to provide a better approximation of the ambient light surrounding the entire device.

In another embodiment, imager 450 may be used to capture the ambient light used for color balancing or imager 450 may be used in conjunction with any or all of ambient light sensors 420 and 440. In either scenario, when imager 450 is used as an ambient light sensor, the imager may be operable in at least two different modes. One mode may be an ambient light evaluating mode and another mode may be an image capture mode.

In ambient light evaluating mode, the imager may be exposed by opening a shutter. The shutter may be opened briefly to capture the ambient light once or for a longer period of time to capture the ambient light a number of times. During the ambient light evaluating mode, the imager may capture ambient light levels and output signals corresponding to the captured ambient light levels. As shown in FIG. 1, the output signals may then be processed by imager output processing unit 94 to produce output values suitable for use by color temperature calculator 100.

Processing in imager output processing unit 94 may be desirable when an imager is used to capture the ambient light for purposes of color balancing. This is because the imager may include a large number of different colored pixels as opposed to the example ambient light sensor 90 which uses only one pixel of each color. Processing may include, for example, averaging all or some of the pixels for each color to determine, for example, average red, green and blue values for the ambient light, selecting the brightest pixels and using the values from those pixels as the red, green and blue values for the ambient light or any other suitable processing method.

If the color balancing is used for image processing, the shutter will open a second time to capture the image and then image processing will take place using the values output by imager output processing unit 94 during the ambient light evaluating mode. Otherwise, the values output by imager output processing unit 94 will be input into color-temperature calculator 100 and the display will be color balanced according to any of the embodiments described above.

There may be advantages and drawbacks to using an imager as the ambient light sensor. One possible advantage is that for applications that already include an imager, additional components do not have to be added specifically for color balancing, thus reducing the number of parts in the device. However, imagers use more power than the example ambient light sensors disclosed above and, therefore, using the imager as the ambient light sensor may decrease battery power more rapidly than if a simpler ambient light sensor were used. Additionally, because imagers typically have many more pixels than would the typical ambient light sensor, the complexity of the processing may increase relative to the ambient light sensors disclosed above to determine, for example, red, green and blue ambient light values usable by the example color-temperature calculator 100. If the device provides for variable focusing, one possible method of reducing processing in the imager output processing unit would be to have the imager capture the image out of focus. In this way, fewer data points (pixels) may be processed to determine the ambient lighting levels.

The embodiments of the present invention may execute automatically to perform automatic white balancing of the display or may be executed manually when, for example, a user presses button 430 shown in FIG. 6A.

In one example automatic mode, ambient light sensor 90 may be configured to sample the ambient lighting once at a predetermined time. For example, ambient light sensor 90 may be configured to sample the ambient lighting after the device has been turned on and a certain period of time has elapsed. In another example automatic mode, ambient light sensor 90 may be configured to sample the ambient lighting continually and to re-calculate the color temperature upon each reading. These example automatic modes may, however, present a problem if, for example, the user is wearing a red shirt and the sensor is, for example, overly sensitive to red light. Here, the ambient light sensor may sense an exaggerated intensity of the red element in the ambient lighting if the user holds the device in such a way that the ambient light sensor is near the shirt. As a result, the white balancing may overcompensate for the red element and the colors displayed by the display may be distorted.

It is desirable for the sensor to detect the appropriate amount of red reflected from the user's shirt that will actually appear in the image. For example, if a user is holding a small white IPOD next to the user's red shirt and is looking at an image containing relatively many white pixels, the white casing of the IPOD will appear to have a red tinge. Because the embodiments described above match the white balance of the image to the white balance of the environment, the white pixels in the image would also appear to the user to have a red tinge so that the user would see a difference in color between the white in the display and the white of the IPOD casing.

If, however, the sensor is overly sensitive to red light, the sensor may detect an exaggerated amount of the red light and overcorrect for it. This problem may be resolved, for example, by configuring ambient light sensor 90 to sample continually while the device is turned on and to average each consecutive sample or to select a maximum sample. In this way, averaging the samples or selecting a maximum sample may lessen the effect of one sample taken, for example, while the user was holding the camera so that the ambient light sensor was located close to the user's shirt.

In one example manual mode, ambient light sensor 90 may be configured to sample the ambient lighting once in response to a user pushing button 430, for example, when the light sensor has a white object in its field of view. In this example, button 430 is a push-button switch for activating the white balancing operation. Button 430 may also be another kind of a switch, a touch screen operation, or any other similar mechanism. In another example manual mode, ambient light sensor 90 may be configured to sample the ambient lighting continually after the button has been depressed and until some other condition is present. For example, ambient light sensor 90 may be configured to sample continually after the button has been pressed and until the button is pressed a second time, until another button is pressed or until the device is turned off, and so on. In this example mode, ambient light sensor 90 may be configured to average together consecutive samples or to select a maximum sample and then re-calculate the color temperature in response to the resulting values.

Color sensors can measure only the light that is eventually passed to the photosensitive elements of the sensor. Accordingly, various techniques are known in the art and applicable to the present invention that may increase the scope of light that is applied to the photosensitive elements. One example technique is to place a lens over the color sensor, over each individual pixel, or both, to direct the ambient light toward the color sensor. To increase the area around the display over which the ambient light sample is taken, a fisheye lens may be placed over the sensor. For example, as shown in FIG. 7, fisheye lens 500 may be a frosted fisheye lens and may be disposed over color sensor 510 to increase the area around the display over which the ambient light sample is taken.

As shown in FIG. 1, one example embodiment of the present invention may include an additional sensor 80 for monitoring light source 60. Sensor 80 may be, for example, color management controller with integrated RGB photosensor ADJD-J823 by Avago Technologies. ADJD-J823 is a CMOS integrated circuit with integrated RGB photosensors designed to be used in a feedback system of a backlight for a display. Using ADJD-J823, during manufacture, a target color is preset for the backlight and the ADJD-J823 is located near the backlight. The integrated RGB photosensor samples the light emitted from the backlight, compares the sampled values to the target color values, and adjusts the drive of the red, green and blue elements of the backlight until the target color is achieved. Alternatively, because the ADJD-J823 adjusts to a single set point, the example system may change the set point for the display so that the display driver may automatically correct the colors. In this way, the light output from the backlight may maintain its color over time and temperature. While this example is described in terms of the ADJD-J823, sensor 80 may be any RGB sensor.

Although the invention is illustrated and described herein with reference to specific embodiments, the invention is not intended to be limited to the details shown. Rather, various modifications may be made in the details within the scope and range of equivalents of the claims and without departing from the invention.

### Conclusion

The present invention is an apparatus and method for adjusting the color balance of a display. A sensor of the apparatus detects the color temperature of ambient light. A controller of the apparatus adjusts the color balance of the emissive display so that the white point of the display matches the white point of the detected ambient light.

While example embodiments of the invention have been shown and described herein, it will be understood that such embodiments are provided by way of example only. Numerous variations, changes and substitutions will occur to those skilled in the art without departing from the invention. Accordingly, it is intended that the appended claims cover all such variations as fall within the scope of the invention.

What is claimed:

1. Apparatus for adjusting an image displayed on a display comprising:
a display unit configured to emit light;
a color sensor configured to detect a color temperature of ambient light; and
a controller configured to control the display unit to adjust a color balance of the light emitted by the display unit based on at least the color temperature of ambient light detected by the color sensor.

2. The apparatus of claim 1,
wherein the display unit is a lighted display and the apparatus further includes a lighting unit having a plurality of component color light sources,
wherein the controller is configured to adjust separately at least one of the respective component color light sources.

3. The apparatus of claim 2,
wherein the lighted display is selected from the group consisting of a reflective display and a transmissive display.

4. The apparatus of claim 1,
wherein the display unit is an emissive display unit.

5. The apparatus of claim 1 further comprising:
drive circuitry for outputting a drive signal containing information for adjusting the light emitted from the display unit,
wherein the display unit is configured to receive an image signal containing information about an image to be displayed and the drive signal,
and wherein the display unit comprises a plurality of individual color components.

6. The apparatus of claim 5,
wherein the controller is configured to control the display unit via the drive circuitry by adjusting an intensity of at least one of the plurality of individual color components.

7. The apparatus of claim 1 further comprising:
a drive unit configured to control the display unit to display the image,
wherein the display unit is configured to receive the image signal and a drive signal containing information for adjusting the light emitted from the display unit,
and wherein the controller is configured to cause the drive unit to adjust a color balance of the light emitted from the lighting unit by adjusting the image signal.

8. The apparatus of claim 1,
wherein the color sensor is an imager.

9. A method of adjusting an image displayed on a display unit comprising the steps of:
detecting a color temperature of ambient light;
processing an image for display on the display unit including adjusting a color balance of light emitted from the display unit based on, at least, the color temperature of ambient light detected by the color sensor; and
displaying the processed image on the display unit.

10. The method of claim 9,
further comprising the step of calculating at least one adjustment ratio for adjusting the color balance of the light emitted from the display unit.

11. The method of claim 10,
wherein the calculating step includes the steps of:
comparing the color temperature of the detected ambient light with at least one adjustment value;
selecting at least one of the adjustment values as an at least one selected adjustment value; and
calculating the at least one adjustment ratio using the at least one selected adjustment value.

12. The method of claim 10,
wherein the calculating step includes the steps of:
comparing the color temperature of the detected ambient light with at least two adjustment values;
interpolating between at least two of the adjustment values to determine at least one interpolated reference value; and
calculating the at least one adjustment ratio using the at least one interpolated reference value.

13. The method of claim 9,
wherein the calculating step includes calculating a color ratio of different colors making up the detected ambient light,
and wherein the adjusting step includes setting a color ratio of the display unit to match the calculated color ratio.

14. The method of claim 9,
wherein the detecting step includes continually sampling the ambient light to obtain a plurality of color temperature samples.

15. The method of claim 14,
wherein the detecting step further includes selecting a maximum color temperature from among the plurality of color temperature samples as the color temperature as the ambient color temperature value.

16. The method of claim 14,
wherein the detecting step further includes averaging the plurality of color temperature samples to obtain an averaged color temperature and selecting the averaged color temperature as the ambient color temperature.

17. The method of claim 13,
wherein the detecting step includes sampling the ambient light once to obtain the ambient color temperature.

18. The method of claim 9, further including the steps of:
determining a lighting level of the ambient light; and
adjusting the color balance of light emitted from the display unit when the lighting level of the ambient light is greater than a predetermined threshold value and not adjusting the color balance of light emitted from the display unit when the lighting level of the ambient light is not greater than the predetermined threshold value.

19. Image display apparatus for storing and displaying image data comprising:
a memory for storing captured image data;
an image processor for processing the captured image data to produce image display signals;
a display device, responsive to the image display signals, for displaying an image representing the scene;
an ambient light sensor for sensing at least first and second color components representing a color temperature of light which is ambient to the image display apparatus;
color temperature correcting circuitry, responsive to the sensed first and second color components, to control at least one of the image processor and the display device to match the color temperature of the displayed image to the color temperature of the light ambient to the image display apparatus.

20. The image display apparatus of claim 19, wherein the color correcting circuitry is configured to:
convert the image display signals from an image color space to a linear color space;
multiply each component of the converted image display signals by a ratio of an ambient light value, corresponding to the component, to a respective reference light value, corresponding to the component, in the linear color space to determine a plurality of converted color signals; and
convert the plurality of converted color signals back to the image color space.

21. The image display apparatus of claim 19, wherein the display device includes a lighted display panel and a light source for providing light to the lighted display panel and the color temperature correcting circuit adjusts the light provided by the light source to match the color temperature of the light ambient to the display device.

22. The image display apparatus of claim 19, further comprising:
a second ambient light sensor disposed such that a light sensitive region of the second ambient light sensor is adjacent a display region of the display device, wherein:
the second ambient light sensor is configured to provide a signal representing an intensity of light emitted from at least a portion of the display region of the display device; and
the color correcting circuitry is configured to adjust at least one of the image display signals responsive to the intensity signal provided by the second ambient light sensor;

23. The image display apparatus of claim 19, further comprising:
a housing,
wherein the display device and the ambient light sensor are disposed on a front surface of the housing.

24. The image display apparatus of claim 19, further comprising:
a housing,
wherein the display device is disposed on a front surface of the housing and the ambient light sensor is disposed on a back surface of the housing.

25. The image display apparatus of claim 22,
further comprising a button configured such that when the button is depressed, the ambient light sensor begins sensing the at least first and second color components.

26. The image display apparatus of claim 19, further comprising a fish eye lens disposed over the ambient light sensor.

27. The image display apparatus of claim 19 further comprising a diffusion lens disposed over the ambient light sensor.
